(19) United States
(12) Patent Application Publication
(10) Pub. No.: US 2025/0237570 A1
(43) Pub. Date: Jul. 24, 2025

(54) LIQUID LEAKAGE DETECTION BAND

(71) Applicant: SHENZHEN ENVICOOL TECHNOLOGY CO., LTD., Shenzhen (CN)

(72) Inventors: Xiaoxin XU, Shenzhen (CN); Xiaolei AI, Shenzhen (CN)

(73) Assignee: SHENZHEN ENVICOOL TECHNOLOGY CO., LTD., Shenzhen (CN)

(21) Appl. No.: 18/814,634

(22) Filed: Aug. 26, 2024

(30) Foreign Application Priority Data
Jan. 19, 2024 (CN) 202410084912.5

(51) Int. Cl. G01M 3/16; G01M 3/18

(52) U.S. Cl. CPC G01M 3/165; G01M 3/182

(57) ABSTRACT

A liquid leakage detection band includes a base band, a first liquid leakage detection wire, and a second liquid leakage detection wire. A preset distance is present between the first liquid leakage detection wire and the second liquid leakage detection wire. The first liquid leakage detection wire is provided with a first liquid leakage detection splice sheet, and the second liquid leakage detection wire is provided with a second liquid leakage detection splice sheet. The base band, the first liquid leakage detection wire, and the second liquid leakage detection wire can be cut along the first liquid leakage detection splice sheet and the second liquid leakage detection splice sheet. With the first liquid leakage detection splice sheet and the second liquid leakage detection splice sheet, wire connection areas can be enlarged to facilitate wire connecting operations after cutting.

### CROSS REFERENCE TO RELATED APPLICATIONS

This application claims the priorities to Chinese patent application No. 202410084912.5, titled “LIQUID LEAKAGE DETECTION BAND”, filed with the China National Intellectual Property Administration Jan. 19, 2024, the entire disclosure of which is hereby incorporated by reference.

### FIELD

The present application relates to the technical field of liquid cooling devices, and in particular to a liquid leakage detection band.

### BACKGROUND

A server generates a huge amount of heat during operation. In order to ensure the normal operation of the server, a heat dissipation process is generally performed on the server. At present, cooling devices, such as an air cooling device or a liquid cooling device, are used for heat dissipation.

For the liquid cooling device, how to prevent liquid leakage from affecting an electronic element on the server is a problem of concern in the industry. The liquid leakage mainly occurs at a liquid supply pipeline and a first connector of the liquid cooling device. Currently, a liquid leakage detection band is mainly used for detection at the liquid supply pipeline. The conventional liquid leakage detection band is expected to be customized according to a length of the liquid supply pipeline. If the length of the liquid supply pipeline changes, the liquid leakage detection band has to be re-customized, which increases the cost of using the liquid leakage detection band.

### SUMMARY

A liquid leakage detection band is provided according to the present application, which can be cut into an expected length according to a length of a liquid supply pipeline, thereby effectively improving the adaptability of the liquid leakage detection band to the liquid supply pipeline.

The liquid leakage detection band includes a base band, and a first liquid leakage detection wire and a second liquid leakage detection wire that are provided on the base band, where
a preset distance is present between the first liquid leakage detection wire and the second liquid leakage detection wire;
the first liquid leakage detection wire is provided with a first liquid leakage detection splice sheet, and the second liquid leakage detection wire is provided with a second liquid leakage detection splice sheet; and
the base band, the first liquid leakage detection wire, and the second liquid leakage detection wire are allowed to be cut along the first liquid leakage detection splice sheet and the second liquid leakage detection splice sheet.

In some embodiments, the first liquid leakage detection splice sheet and the second liquid leakage detection splice sheet extend towards each other, and a preset gap is present between the first liquid leakage detection splice sheet and the second liquid leakage detection splice sheet.

In some embodiments, the liquid leakage detection band includes a first connector, the first connector is provided with a first connecting wire and a second connecting wire, the first connecting wire is configured to be connected to the first liquid leakage detection splice sheet being cut, and the second connecting wire is configured to be connected to the second liquid leakage detection splice sheet being cut.

In some embodiments, the first liquid leakage detection splice sheet includes two first splice sub-sheets that are distributed along a length direction of the first liquid leakage detection wire and are spaced apart from each other, the second liquid leakage detection splice sheet includes two second splice sub-sheets that are distributed along a length direction of the second liquid leakage detection wire and are spaced apart from each other, and the base band, the first liquid leakage detection wire, and the second liquid leakage detection wire are allowed to be cut between the two first splice sub-sheets and between the two second splice sub-sheets.

In some embodiments, a cutting mark line is provided on the base band, and the cutting mark line passes through the first liquid leakage detection wire, the first liquid leakage detection splice sheet, the second liquid leakage detection wire, and the second liquid leakage detection splice sheet.

In some embodiments, at least one first detection sheet extending towards the second liquid leakage detection wire is provided at a side of the first liquid leakage detection wire, and/or at least one second detection sheet extending towards the first liquid leakage detection wire is provided at a side of the second liquid leakage detection wire.

In some embodiments, the at least one first detection sheet and the at least one second detection sheet are arranged alternatively, and a preset distance is present between the at least one first detection sheet and the at least one second detection sheet.

In some embodiments, the liquid leakage detection band includes a first wire break detection wire and a second wire break detection wire that are arranged on the base band, an end of the first wire break detection wire is connected to an end of the first liquid leakage detection wire, and an end of the second wire break detection wire is connected to an end of the second liquid leakage detection wire.

In some embodiments, the first wire break detection wire is provided with a first wire break detection splice sheet, a first end of the first wire break detection wire is flush with a first end of the first liquid leakage detection wire, and a distance between the first wire break detection splice sheet and the first end of the first wire break detection wire is equal to a distance between the first liquid leakage detection splice sheet and the first end of the first liquid leakage detection wire; and
the second wire break detection wire is provided with a second wire break detection splice sheet, a first end of the second wire break detection wire is flush with a first end of the second liquid leakage detection wire, and a distance between the second wire break detection splice sheet and the first end of the second wire break detection wire is equal to a distance between the second liquid leakage detection splice sheet and the first end of the second liquid leakage detection wire.

In some embodiments, the first wire break detection splice sheet extends away from the first liquid leakage detection wire, and the second wire break detection splice sheet extends away from the second liquid leakage detection wire.

Compared with the prior art, the above technical solutions have the following advantages.

According to the liquid leakage detection band provided in the present application, the base band, the first liquid leakage detection wire, and the second liquid leakage detection wire can be cut along bodies of the first liquid leakage detection splice sheet and the second liquid leakage detection splice sheet. With the first liquid leakage detection splice sheet and the second liquid leakage detection splice sheet, wire connection areas can be enlarged to facilitate wire connecting operations after cutting. In this way, the liquid leakage detection band may be cut or spliced into the expected length according to the length of the liquid supply pipeline, thereby effectively improving the adaptability of the liquid leakage detection band to the liquid supply pipeline.

### BRIEF DESCRIPTION OF THE DRAWINGS

For more clearly illustrating embodiments of the present application or the technical solutions in the conventional technology, drawings referred to describe the embodiments or the conventional technology will be briefly described hereinafter. Apparently, the drawings in the following description are only some examples of the present application, and for those skilled in the art, other drawings may be obtained based on these drawings without any creative efforts.

FIG. 1 is a schematic structural view of a liquid leakage detection band according to an embodiment of the present application;

FIG. 2 is a schematic structural view of a liquid leakage detection band according to another embodiment of the present application;

FIG. 3 is a schematic structural view of a first connector of a liquid leakage detection band according to an embodiment of the present application; and

FIG. 4 is a schematic structural view of a second connector of a liquid leakage detection band according to an embodiment of the present application.

### REFERENCE NUMERALS

10 base band,
20 first liquid leakage detection wire,
21 first liquid leakage detection splice sheet,
211 first splice sub-sheet,
22 first detection sheet,
30 second liquid leakage detection wire,
31 second liquid leakage detection splice sheet,
311 second splice sub-sheet,
32 second detection sheet,
40 cutting mark line,
50 first wire break detection wire,
51 first wire break detection splice sheet,
511 first break detection splice sub-sheet,
60 second wire break detection wire,
61 second wire break detection splice sheet,
611 second break detection splice sub-sheet,
70 first connector,
71 first connecting wire,
72 second connecting wire,
80 second connector,
81 first end portion connecting wire,
82 second end portion connecting wire,
83 first wire break detection wire end portion splice sheet,
84 first liquid leakage detection wire end portion splice sheet,
85 second liquid leakage detection wire end portion splice sheet,
86 second wire break detection wire end portion splice sheet.

### DETAILED DESCRIPTION OF THE EMBODIMENTS

Technical solutions according to the embodiments of the present application will be described clearly and completely as follows in conjunction with the accompany drawings in the embodiments of the present application. It is obvious that the described embodiments are only a part of the embodiments according to the present application, rather than all of the embodiments. All the other embodiments obtained by those skilled in the art based on the embodiments in the present application without any creative work belong to the scope of protection of the present application.

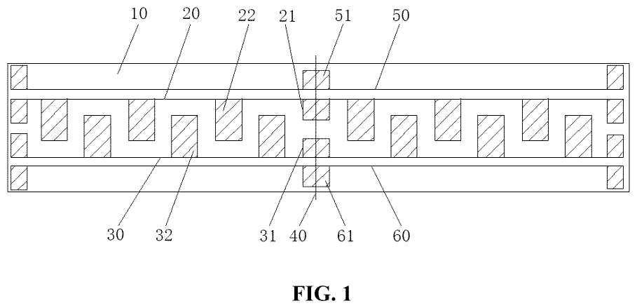

Referring to FIG. 1, a liquid leakage detection band is provided according to an embodiment of the present application. The liquid leakage detection band includes a base band 10, and a first liquid leakage detection wire 20 and a second liquid leakage detection wire 30 that are provided on the base band 10. The base band 10 may be a flexible band. The first liquid leakage detection wire 20 and the second liquid leakage detection wire 30 may be formed on the base band 10 by electroplating. The base band 10 may be strip-shaped. The first liquid leakage detection wire 20 and the second liquid leakage detection wire 30 may be provided on the base band 10 in a straight manner, i.e., the first liquid leakage detection wire 20 and the second liquid leakage detection wire 30 extend along a length direction of the base band 10. Alternatively, the first liquid leakage detection wire 20 and the second liquid leakage detection wire 30 may be provided in a consecutively bending manner, or in a wavy manner. A preset distance is present between the first liquid leakage detection wire 20 and the second liquid leakage detection wire 30. When liquid leakage in a liquid cooling device drops down and contacts the first liquid leakage detection wire 20 and the second liquid leakage detection wire 30 at the same time, the first liquid leakage detection wire 20 and the second liquid leakage detection wire 30 are short-circuited, such that liquid leakage is detected. The liquid leakage detection band is applicable to liquid leakage detection of a liquid supply pipeline or other structures of the liquid cooling device. The first liquid leakage detection wire 20 is provided with a first liquid leakage detection splice sheet 21, and the second liquid leakage detection wire 30 is provided with a second liquid leakage detection splice sheet 31. A position of the first liquid leakage detection splice sheet 21 along a length direction of the first liquid leakage detection wire 20 is the same as a position of the second liquid leakage detection splice sheet 31 along a length direction of the second liquid leakage detection wire 30. For example, as shown in FIG. 1, a distance between the first liquid leakage detection splice sheet 21 and a left end of the base band 10 is equal to a distance between the second liquid leakage detection splice sheet 31 and the left end of the base band 10. The base band 10, the first liquid leakage detection wire 20, and the second liquid leakage detection wire 30 can be cut at the first liquid leakage detection splice sheet 21 and the second liquid leakage detection splice sheet 31. With the first liquid leakage detection splice sheet 21 and the second liquid leakage detection splice sheet 31, wire connection areas can be enlarged to facilitate wire connecting operations after cutting. Preferably, a width of the first liquid leakage detection splice sheet 21 is larger than a width of the first liquid leakage detection wire 20, and a width of the second liquid leakage detection splice sheet 31 is larger than a width of the second liquid leakage detection wire 30. When a relatively short liquid leakage detection band is needed, the liquid leakage detection band may be cut at the first liquid leakage detection splice sheet 21 and the second liquid leakage detection splice sheet 31. When a relatively long liquid leakage detection band is needed, another liquid leakage detection band may be connected at a position where the first liquid leakage detection splice sheet 21 and the second liquid leakage detection splice sheet 31 are cut. In this way, the liquid leakage detection band may be cut or spliced to an expected length according to a length of the liquid supply pipeline, thereby effectively improving the adaptability of the liquid leakage detection band to the liquid supply pipeline. Multiple cuttable structures of the first liquid leakage detection splice sheet 21 and the second liquid leakage detection splice sheet 31 may be provided on the first liquid leakage detection wire 20 and the second liquid leakage detection wire 30, and the multiple cuttable structures may be evenly or unevenly distributed along the length direction of the base band 10.

In some embodiments, the first liquid leakage detection splice sheet 21 and the second liquid leakage detection splice sheet 31 extend towards each other. As shown in FIG. 1, the first liquid leakage detection splice sheet 21 and the second liquid leakage detection splice sheet 31 are arranged towards each other, and a preset gap is present between the first liquid leakage detection splice sheet 21 and the second liquid leakage detection splice sheet 31. When the liquid leakage contacts the first liquid leakage detection splice sheet 21 and the second liquid leakage detection splice sheet 31 at the same time, the first liquid leakage detection wire 20 and the second liquid leakage detection wire 30 are conducted and short-circuited. In addition, the first liquid leakage detection splice sheet 21 and the second liquid leakage detection splice sheet 31 may extend away from each other.

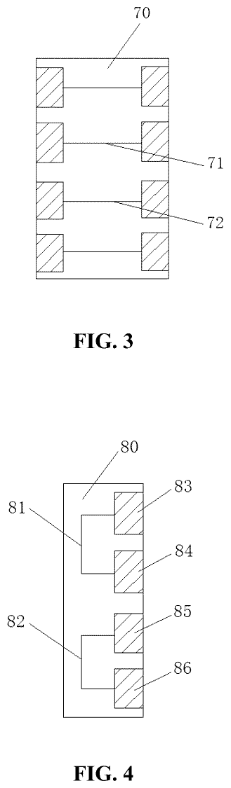

In some embodiments, as shown in FIG. 3, the liquid leakage detection band further includes a first connector 70. A first connecting wire 71 and a second connecting wire 72 are provided on the first connector 70. The first connecting wire 71 may be connected to the first liquid leakage detection splice sheet 21 which is cut, and the second connecting wire 72 may be connected to the second liquid leakage detection splice sheet 31 which is cut. To facilitate the connection between the first connector 70 and two liquid leakage detection bands which are cut, the first connector 70 is further provided with two first wire splice sheets that are respectively connected to two ends of the first connecting wire 71, and the first connector 70 is provided with two second wire splice sheets that are respectively connected to two ends of the second connecting wire 72. When being connected, the two first wire splice sheets respectively contact two first liquid leakage detection splice sheets 21 of two liquid leakage detection bands to be connected, and the two second wire splice sheets respectively contact two second liquid leakage detection splice sheets 31 of the two liquid leakage detection bands to be connected. Since they are in surface-to-surface contact, connections of the bands become easier.

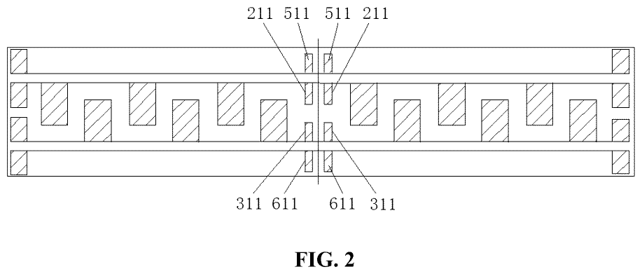

In some embodiments, as shown in FIG. 2, the first liquid leakage detection splice sheet 21 includes two first splice sub-sheets 211 that are distributed along the length direction of the first liquid leakage detection wire 20 and are spaced apart from each other. The two first splice sub-sheets 211 are arranged adjacent to each other, and are preferably of a same size. A region between the two first splice sub-sheets 211 can be cut. The second liquid leakage detection splice sheet 31 includes two second splice sub-sheets 311 that are distributed along the length direction of the second liquid leakage detection wire 30 and are spaced apart from each other. The two second splice sub-sheets 311 are arranged adjacent to each other, and are preferably of a same size. A region between the two first splice sub-sheets 311 can be cut. When the liquid leakage detection band is needed to be cut, the base band 10, the first liquid leakage detection wire 20, and the second liquid leakage detection wire 30 can be cut between the two first splice sub-sheets 211 and between the two second splice sub-sheets 311. As shown in FIG. 2, the liquid leakage detection band may be cut at a position between the two first splice sub-sheets 211 and between the two second splice sub-sheets 311 along a direction perpendicular to the base band 10. In the present embodiment, the first liquid leakage detection splice sheet 21 and the second liquid leakage detection splice sheet 31 are each designed into a two-sheet structure, which makes the liquid leakage detection band easy to be cut by a user. In this way, a problem that, after the liquid leakage detection band is cut, a first liquid leakage detection splice sheet 21 and a second liquid leakage detection splice sheet 31 on one segment have a relatively small area, while a first liquid leakage detection splice sheet 21 and a second liquid leakage detection splice sheet 31 on the other segment have a relatively large area, is prevented.

In some embodiments, a cutting mark line 40 is provided on the base band 10. The cutting mark line 40 may be an indentation, or a line that is drawn. For example, a line is drawn, which has a color that is easy to identify and is distinguishable from the base band 10, the first liquid leakage detection wire 20, the first liquid leakage detection splice sheet 21, the second liquid leakage detection wire 30, and the second liquid leakage detection splice sheet 31. The cutting mark line 40 passes through the first liquid leakage detection wire 20, the first liquid leakage detection splice sheet 21, the second liquid leakage detection wire 30, and the second liquid leakage detection splice sheet 31. When the liquid leakage detection band is needed to be cut, the user may cut along the cutting mark line 40. In this way, the cutting is prevented from being misaligned, and it becomes easier for the user to find the position for cutting, thereby increasing the cutting efficiency.

In some embodiments, at least one first detection sheet 22 extending towards the second liquid leakage detection wire 30 is provided at a side of the first liquid leakage detection wire 20, and/or at least one second detection sheet 32 extending towards the first liquid leakage detection wire 20 is provided at a side of the second liquid leakage detection wire 30. The detection sheet of the liquid leakage detection band has three distribution manners. In a first manner, only the first detection sheet 22 is provided at the side of the first liquid leakage detection wire 20. In a second manner, only the second detection sheet 32 is provided at the side of the second liquid leakage detection wire 30. In a third manner, the first detection sheet 22 is provided at the side of the first liquid leakage detection wire 20, and the second detection sheet 32 is provided at the side of the second liquid leakage detection wire 30 at the same time. The first detection sheet 22 does not contact the second detection sheet 32, the first detection sheet 22 does not contact the second liquid leakage detection wire 30, and the second detection sheet 32 does not contact the first liquid leakage detection wire 20. During detection, the liquid leakage can be detected when the liquid leakage contacts the first detection sheet 22 and the second detection sheet 32 at the same time, or contacts the first detection sheet 22 and the second liquid leakage detection wire 30 at the same time, or contacts the second detection sheet 32 and the first liquid leakage detection wire 20 at the same time, or contacts the first liquid leakage detection wire 20 and the second liquid leakage detection wire 30 at the same time. Therefore, the precision of the liquid leakage detection is effectively improved when compared with a current solution that the liquid leakage is detected only by the first liquid leakage detection wire 20 and the second liquid leakage detection wire 30.

In some embodiments, the first detection sheet 22 and the second detection sheet 32 are arranged alternatively, and a preset distance is present between the first detection sheet 22 and the second detection sheet 32. As shown in FIG. 1, the first detection sheet 22 and the second detection sheet 32 are distributed in a comb shape. A width of the first detection sheet 22 and a width of the second detection sheet 32 may be larger than, smaller than or equal to half of a distance between the first liquid leakage detection wire 20 and the second liquid leakage detection wire 30. It should be noted that, the first detection sheet 22 and the second detection sheet 32 shown in FIG. 1 and FIG. 2 are each of a rectangular structure. Besides, the first detection sheet 22 and the second detection sheet 32 may be triangular, trapezoidal, L-shaped, T-shaped or the like, as long as the first detection sheet 22 extends towards the second liquid leakage detection wire 30, and the second detection sheet 32 extends towards the first liquid leakage detection wire 20.

In some embodiments, the liquid leakage detection band further includes a first wire break detection wire 50 and a second wire break detection wire 60 that are provided on the base band 10. An end of the first wire break detection wire 50 is connected to an end of the first liquid leakage detection wire 20, and an end of the second wire break detection wire 60 is connected to an end of the second liquid leakage detection wire 30. During a normal detection process, if the first liquid leakage detection wire 20 is not broken, there is a current passing through the first wire break detection wire 50. If the first liquid leakage detection wire 20 is broken, there is no current passing through the first wire break detection wire 50. Similarly, if the second liquid leakage detection wire 30 is broken, there is no current passing through the second wire break detection wire 60 as well. In this way, with the first wire break detection wire 50 and the second wire break detection wire 60, whether the first liquid leakage detection wire 20 and the second liquid leakage detection wire 30 are broken can be determined, and thus the first liquid leakage detection wire 20 and the second liquid leakage detection wire 30 can be repaired in time, which prevents a problem that the wire breaking cannot be detected in time. Therefore, the detection precision of the liquid leakage detection band is effectively improved.

In some embodiments, as shown in FIG. 1 and FIG. 2, the first wire break detection wire 50 is provided with a first wire break detection splice sheet 51. A first end of the first wire break detection wire 50 is flush with a first end of the first liquid leakage detection wire 20, and a distance between the first wire break detection splice sheet 51 and the first end of the first wire break detection wire 50 is equal to a distance between the first liquid leakage detection splice sheet 21 and the first end of the first liquid leakage detection wire 20. The second wire break detection wire 60 is provided with a second wire break detection splice sheet 61. A first end of the second wire break detection wire 60 is flush with a first end of the second liquid leakage detection wire 30, and a distance between the second wire break detection splice sheet 61 and the first end of the second wire break detection wire 60 is equal to a distance between the second liquid leakage detection splice sheet 31 and the first end of the second liquid leakage detection wire 30. The first end of the first liquid leakage detection wire 20, the first end of the second liquid leakage detection wire 30, the first end of the first wire break detection wire 50, and the first end of the second wire break detection wire 60 are the same end, which is a left end or a right end as shown in FIG. 1. With the first wire break detection splice sheet 51, a wire connection area of the first wire break detection wire 50 can be enlarged to facilitate the connection of the first wire break detection wire 50. With the second wire break detection splice sheet 61, a wire connection area of the second wire break detection wire 60 can be enlarged to facilitate the connection of the second wire break detection wire 60. As shown in FIG. 1, the first wire break detection wire 50 is located at an outer side of the first liquid leakage detection wire 20, and the second wire break detection wire 60 is located at an outer side of the second liquid leakage detection wire 30. The first wire break detection splice sheet 51 extend away from the first liquid leakage detection wire 20, and the second wire break detection splice sheet 61 extend away from the second liquid leakage detection wire 30. As shown in FIG. 2, the first wire break detection splice sheet 51 includes two first break detection splice sub-sheets 511 that are spaced apart along a length direction of the first wire break detection wire 50, and the second wire break detection splice sheet 61 includes two second break detection splice sub-sheets 611 that are spaced apart along a length direction of the second wire break detection wire 60. The liquid leakage detection band can be cut between the two first break detection splice sub-sheets 511 and between the two second break detection splice sub-sheets 611.

In some embodiments, the liquid leakage detection band further includes a second connector 80. The second connector 80 is provided with a first end portion connecting wire 81 and a second end portion connecting wire 82. A first wire break detection wire end portion splice sheet 83, a first liquid leakage detection wire end portion splice sheet 84, a second liquid leakage detection wire end portion splice sheet 85, and a second wire break detection wire end portion splice sheet 86 are provided at a side of the second connector 80. Two ends of the first end portion connecting wire 81 are respectively connected to the first wire break detection wire end portion splice sheet 83 and the first liquid leakage detection wire end portion splice sheet 84, and two ends of the second end portion connecting wire 82 are respectively connected to the second liquid leakage detection wire end portion splice sheet 85 and the second wire break detection wire end portion splice sheet 86. For the liquid leakage detection band being cut, one end of the liquid leakage detection band can be connected to another liquid leakage detection band through the first connector 70, and the other end of the liquid leakage detection band is connected to the second connector 80. The first wire break detection wire end portion splice sheet 83 contacts the first wire break detection splice sheet 51, and the first liquid leakage detection wire end portion splice sheet 84 contacts the first liquid leakage detection splice sheet 21. The second liquid leakage detection wire end portion splice sheet 85 contacts the second liquid leakage detection splice sheet 31, and the second wire break detection wire end portion splice sheet 86 contacts the second wire break detection splice sheet 61. In this way, the first liquid leakage detection wire 20 is connected to the first wire break detection wire 50, and the second liquid leakage detection wire 30 is connected to the second wire break detection wire 60.

It should be noted that, in this specification, relational terms such as “first” and “second” are merely intended to distinguish one entity from other entities, and do not require or imply any actual relationships or sequences among these entities.

The above embodiments in this specification are described in a progressive manner. Each of the embodiments is mainly focused on describing its differences from other embodiments, and references may be made among these embodiments with respect to the same or similar portions among these embodiments.

The liquid leakage detection band according to the present application is described in detail hereinbefore. The principle and the embodiments of the present application are illustrated herein by specific examples. The above description of examples is only intended to help the understanding of the method and the idea of the present application. It should be noted that, for those skilled in the art, a few of modifications and improvements may be made to the present application without departing from the principle of the present application, and these modifications and improvements are also deemed to fall into the scope of the present application defined by the claims.

1. A liquid leakage detection band, comprising a base band, and a first liquid leakage detection wire and a second liquid leakage detection wire that are provided on the base band, wherein
a preset distance is present between the first liquid leakage detection wire and the second liquid leakage detection wire;
the first liquid leakage detection wire is provided with a first liquid leakage detection splice sheet, and the second liquid leakage detection wire is provided with a second liquid leakage detection splice sheet; and
the base band, the first liquid leakage detection wire, and the second liquid leakage detection wire are allowed to be cut at the first liquid leakage detection splice sheet and the second liquid leakage detection splice sheet.

2. The liquid leakage detection band according to claim 1, wherein the first liquid leakage detection splice sheet and the second liquid leakage detection splice sheet extend towards each other, and a preset gap is present between the first liquid leakage detection splice sheet and the second liquid leakage detection splice sheet.

3. The liquid leakage detection band according to claim 1, comprising a first connector, wherein the first connector is provided with a first connecting wire and a second connecting wire, the first connecting wire is configured to be connected to the first liquid leakage detection splice sheet which is cut, and the second connecting wire is configured to be connected to the second liquid leakage detection splice sheet which is cut.

4. The liquid leakage detection band according to claim 1, wherein the first liquid leakage detection splice sheet comprises two first splice sub-sheets that are distributed along a length direction of the first liquid leakage detection wire and are spaced apart from each other, the second liquid leakage detection splice sheet comprises two second splice sub-sheets that are distributed along a length direction of the second liquid leakage detection wire and are spaced apart from each other, and the base band, the first liquid leakage detection wire, and the second liquid leakage detection wire are allowed to be cut between the two first splice sub-sheets and between the two second splice sub-sheets.

5. The liquid leakage detection band according to claim 1, wherein a cutting mark line is provided on the base band, and the cutting mark line passes through the first liquid leakage detection wire, the first liquid leakage detection splice sheet, the second liquid leakage detection wire, and the second liquid leakage detection splice sheet.

6. The liquid leakage detection band according to claim 1, wherein at least one first detection sheet extending towards the second liquid leakage detection wire is provided at a side of the first liquid leakage detection wire, and/or at least one second detection sheet extending towards the first liquid leakage detection wire is provided at a side of the second liquid leakage detection wire.

7. The liquid leakage detection band according to claim 6, wherein the at least one first detection sheet and the at least one second detection sheet are arranged alternatively, and a preset distance is present between the at least one first detection sheet and the at least one second detection sheet.

8. The liquid leakage detection band according to claim 1, comprising a first wire break detection wire and a second wire break detection wire that are arranged on the base band, wherein an end of the first wire break detection wire is connected to an end of the first liquid leakage detection wire, and an end of the second wire break detection wire is connected to an end of the second liquid leakage detection wire.

9. The liquid leakage detection band according to claim 8, wherein
the first wire break detection wire is provided with a first wire break detection splice sheet, a first end of the first wire break detection wire is flush with a first end of the first liquid leakage detection wire, and a distance between the first wire break detection splice sheet and the first end of the first wire break detection wire is equal to a distance between the first liquid leakage detection splice sheet and the first end of the first liquid leakage detection wire; and
the second wire break detection wire is provided with a second wire break detection splice sheet, a first end of the second wire break detection wire is flush with a first end of the second liquid leakage detection wire, and a distance between the second wire break detection splice sheet and the first end of the second wire break detection wire is equal to a distance between the second liquid leakage detection splice sheet and the first end of the second liquid leakage detection wire.

10. The liquid leakage detection band according to claim 9, wherein the first wire break detection splice sheet extends away from the first liquid leakage detection wire, and the second wire break detection splice sheet extends away from the second liquid leakage detection wire.

11. The liquid leakage detection band according to claim 2, comprising a first wire break detection wire and a second wire break detection wire that are arranged on the base band, wherein an end of the first wire break detection wire is connected to an end of the first liquid leakage detection wire, and an end of the second wire break detection wire is connected to an end of the second liquid leakage detection wire.

12. The liquid leakage detection band according to claim 3, comprising a first wire break detection wire and a second wire break detection wire that are arranged on the base band, wherein an end of the first wire break detection wire is connected to an end of the first liquid leakage detection wire, and an end of the second wire break detection wire is connected to an end of the second liquid leakage detection wire.

13. The liquid leakage detection band according to claim 4, comprising a first wire break detection wire and a second wire break detection wire that are arranged on the base band, wherein an end of the first wire break detection wire is connected to an end of the first liquid leakage detection wire, and an end of the second wire break detection wire is connected to an end of the second liquid leakage detection wire.

14. The liquid leakage detection band according to claim 5, comprising a first wire break detection wire and a second wire break detection wire that are arranged on the base band, wherein an end of the first wire break detection wire is connected to an end of the first liquid leakage detection wire, and an end of the second wire break detection wire is connected to an end of the second liquid leakage detection wire.

15. The liquid leakage detection band according to claim 6, comprising a first wire break detection wire and a second wire break detection wire that are arranged on the base band, wherein an end of the first wire break detection wire is connected to an end of the first liquid leakage detection wire, and an end of the second wire break detection wire is connected to an end of the second liquid leakage detection wire.

16. The liquid leakage detection band according to claim 7, comprising a first wire break detection wire and a second wire break detection wire that are arranged on the base band, wherein an end of the first wire break detection wire is connected to an end of the first liquid leakage detection wire, and an end of the second wire break detection wire is connected to an end of the second liquid leakage detection wire.
